(19) United States
(12) Patent Application Publication
(10) Pub. No.: US 2004/0008725 A1
(43) Pub. Date: Jan. 15, 2004

(54) Method and an interface circuit configurable in two communication protocol modes

(75) Inventors: Daniel John McNamara, Limerick (IE); Dolores Michelle Mahoney, Kerry (IE); Claire Margaret O'Keeffe, Galway (IE); Kieran Gerard Burke, Clare (IE); Carl Patrick Martin, Limerick (IE)

Correspondence Address: Steven J. Henry, Wolf, Greenfield & Sacks, P.C., 600 Atlantic Avenue, Boston, MA, 02210, US

(73) Assignee: Analog Devices, Inc., Norwood, MA

(21) Appl. No.: 10/618,225

(22) Filed: Jul. 11, 2003

Related U.S. Application Data
(60) Provisional application No. 60/395,845, filed on Jul. 15, 2002.
(60) Provisional application No. 60/429,633, filed on Nov. 27, 2002.

(51) Int. Cl. H04J 3/16

(52) U.S. Cl. 370/466; 370/395.5

(57) ABSTRACT

An interface circuit (1) for facilitating communication between an integrated circuit (2) and an external device (not shown) in either SPI protocol or one or both of I²C and SMBus protocols, comprises a signal processing circuit (7), which is configurable in I²C/SMBus and SPI protocol modes, and four communication terminals, namely, a CLK pin (3), and ADD/DOUT pin (4), and SDA/DIN pin (5) and a \overline{CE} pin (6). On power-up of the interface circuit (1) the signal processing circuit (7) is configured in I²C/SMBus protocol mode by a first mode select signal (V_{dd}) applied to a mode select input port (10) by a multiplexer (15) in response to a logic low switch signal from a switch signal flip-flop (22). A first state machine (20) outputs a logic low signal to an AND gate (21) for so long as the \overline{CE} pin (6) remains continuously high or low, thus holding a reset input of the switch signal flip-flop (22) low. The first state machine (20) outputs a logic high in response to a protocol select signal on the \overline{CE} pin (6), thus causing the reset input to go high, and in turn causing the switch signal flip-flop (22) to output a logic high switch signal, which operates the multiplexer (15) for switching a second mode select signal, namely, ground to the mode select input port (10) for configuring the signal processing circuit (7) in the SPI protocol mode. A locking circuit (23) holds the reset input of the switch signal flip-flop (22) low, thus maintaining the switch signal from the switch signal flip-flop (22) in the logic high state until the interface circuit is powered-down. Communication is carried out in SPI protocol using all four communication pins (3,4,5,6) and in I²C/SMBus protocol using only the CLK pin (3) and the SDA/DIN pin (5).

### CROSS-REFERENCE TO RELATED APPLICATIONS

This application claims the benefit, under 35 U.S.C. §119(e), of U.S. Provisional Application Serial No. 60/395,845, filed Jul. 15, 2002, entitled “INTERFACE CIRCUIT FOR COMMUNICATING IN A PLURALITY OF COMMUNICATION PROTOCOLS” and Provisional Application Serial No. 60/429,633, filed Nov. 27, 2002, entitled “INTERFACE CIRCUIT FOR COMMUNICATING IN TWO COMMUNICATION PROTOCOLS” which applications are hereby incorporated herein by reference.

### FIELD OF THE INVENTION

The present invention relates to an interface circuit configurable in two communication protocol modes for facilitating communication in two communication protocols, and in particular, the invention relates to an interface circuit for interfacing an associated device with one or more external devices, and which is configurable in either one of the two communication protocol modes for facilitating communication between the associated device and the external device or devices in the respective communication protocols. The invention also relates to an integrated circuit comprising the associated device and the interface circuit, and the invention further relates to a method for communicating through an interface circuit between an associated device with one or more external devices in either one of two communication protocols.

### BACKGROUND TO THE INVENTION

As the speed, capacity and functionality of integrated circuits increases, the number of input/output pins required in order to communicate an integrated circuit with another integrated circuit has significantly increased. While the actual physical size of such integrated circuits has not increased by any significant extent, the size of packages containing such integrated circuits has increased significantly. The large increase in the package size is largely attributable to the increase in the pin count required to facilitate communication between the various integrated circuits. This is undesirable, since the area required on a printed circuit board for such packaged integrated circuits is significantly out of proportion to the actual size of the integrated circuit, and thus, larger printed circuit boards are required for accommodating such integrated circuits, which militates against miniaturisation.

In an effort to reduce the pin count, there has been a significant shift from parallel data communication to serial data communication. While the pin count required for serial data communication is considerably less than the pin count required for parallel data communication, nonetheless, serial data communication as well as requiring one or two serial data pins, for data in and data out, may also require separate address pins, a clock signal pin, and other pins to assist in interpreting the serial data on the serial data pin or pins.

Additionally, there are many different serial data communication protocols under which data is communicated serially between integrated circuits. The different communication protocols have different advantages and disadvantages, and the choice of protocol, in general, depends on the function of the particular integrated circuit. Thus, in general, it is important that integrated circuits should be capable of communicating in a number of different communication protocols. This either requires a manufacturer to produce a number of different versions of the same integrated circuit for communicating in various different protocols, or alternatively, providing an interface circuit associated with the integrated circuit, and generally, fabricated with the integrated circuit. The interface circuit would be capable of communicating with the external device or devices in a plurality of different protocols.

In general, such interface circuits comprise a plurality of signal processing circuits, one signal processing circuit being provided for each protocol in which the interface circuit is required to communicate. The signal processing circuits convert received signals in the respective different protocols into signals which can then be written to the integrated circuit. Where two-way communication is required, the signal processing circuits convert data read from the integrated circuit into the appropriate protocol to be communicated to the external device.

However, such integrated circuits, in general, require separate input/output pins for each protocol in which the interface circuit is capable of communicating, and additionally, one or more protocol select pins for receiving a protocol select signal for selecting the appropriate signal processing circuit for communicating in the selected communication protocol. This, thus, significantly increases the pin count of such integrated circuits, which is undesirable. For example, three commonly used protocols are SPI, I²C and SMBus. The SPI protocol for two-way communication requires a minimum of four communication pins, namely, a chip enable pin, a clock pin, a serial data in pin, and a serial data out pin. However, where one-way communication only is required, for example, where data is only to be read out of the device associated with the interface circuit, the serial data in pin may be omitted. In many implementations of SPI protocol, a read/write pin is also required, and thus, in the case of two-way communication five pins may be required to communicate in SPI protocol. I²C and SMBus protocols are substantially similar to each other, and both require two pins, namely, a clock pin and a serial data address pin. Thus, in order for an integrated circuit to support the SPI and I²C or SMBus protocols, six, and possibly seven communication pins would be required, and at least one additional protocol select pin for receiving a protocol select signal. This would require a pin count of seven and possibly eight pins. These pins would be in addition to other pins of the integrated circuit, for example, power supply and ground pins, and other control pins, as well as other voltage in and voltage out pins, and general purpose input/output (GPIO) pins, which may be digital or analogue input/output pins.

An interface circuit with a reduced pin count is disclosed in U.S. Pat. Specification No. 6,038,400 of Bell, et al. Bell discloses an interface circuit which is selectively configurable to communicate in a plurality of communication protocols with external devices. The interface circuit of Bell is provided with one set of communication terminals, and the signals in the various different communication protocols are applied to the one set of communication terminals. The interface circuit comprises protocol identifying circuitry which monitors the signals on the communication terminals, and based upon the characteristics of the signals, a signature of the communication protocol is determined and thus the protocol is identified. On identifying the protocol, the protocol identifying circuitry outputs a mode select signal to protocol implementing circuitry, which is appropriately configured to communicate the integrated circuit with the external device in the identified protocol.

While the interface circuit of Bell has advantages, in particular due to the fact that the number of communication terminals is significantly reduced, and thus the total pin count, a significant disadvantage of the interface circuit of Bell is that communication must first commence before a determination of the protocol can be made. Where delays occur in determining the protocol, the initial part of the communication is lost. This is undesirable. A further disadvantage of the integrated circuit of Bell is that the protocol identifying circuitry is relatively complex, and as well as resulting in the normal disadvantages of complex circuitry, also has the disadvantage of a relatively slow response time, thus further leading to greater loss of the initial part of the communication.

There is therefore a need for an interface circuit which is configurable to communicate in either one of a first and second communication protocol for interfacing an associated device with one or more external devices which minimises the pin count required, while at the same time avoids loss of data being communicated.

The present invention is directed towards providing such an interface circuit, and the invention is also directed towards providing an integrated circuit comprising the interface circuit. The invention is further directed towards providing a method for communicating between an integrated circuit and one or more external devices in either of a first and second protocol.

### SUMMARY OF THE INVENTION

According to the invention there is provided an interface circuit alternately configurable in one of a first communication protocol mode for communicating in a first communication protocol and a second communication protocol mode for communicating in a second communication protocol, and for interfacing an associated device with an external device for communicating the associated device with the external device in one of the first communication protocol and the second communication protocol, the interface circuit being configured in the first protocol mode on power-up, the interface circuit comprising

a plurality of communication terminals for communicating signals in the first and second protocols between the interface circuit and the external device, the number of communication terminals required not exceeding the number of communication terminals required to communicate in the one of the first and second protocols which requires the greatest number of communication terminals, and

a monitoring circuit for monitoring one of the communication terminals for a protocol select signal, and being responsive to the protocol select signal for configuring the interface circuit in the second protocol mode.

Preferably, a locking circuit responsive to the monitoring circuit detecting the protocol select signal is provided for locking the interface circuit configured in the second protocol mode.

In one embodiment of the invention the locking circuit is responsive to the monitoring circuit detecting the protocol select signal for locking the interface circuit configured in the first protocol mode.

Advantageously, the locking circuit releasably locks the interface circuit in the configured protocol mode. Ideally, the locking circuit is responsive to powering down of the interface circuit for releasing the interface circuit from the configured protocol mode.

In one embodiment of the invention a signal processing circuit is provided, the signal processing circuit being selectively and alternately configurable in one of the first and second protocol modes for processing the communication signals in the respective first and second protocols, the signal processing circuit being configurable in the respective first and second protocol modes in response to first and second mode select signals, respectively.

In another embodiment of the invention a switch circuit is provided, the switch circuit being selectively and alternately operable in one of a first state and a second state in response to the monitoring circuit, the switch circuit being operable in the first state in response to the monitoring circuit on power-up of the interface circuit for applying the first mode select signal to the signal processing circuit.

In one embodiment of the invention the switch circuit is operable in the second state in response to the monitoring circuit detecting the protocol select signal for applying the second mode select signal to the signal processing circuit.

In another embodiment of the invention the switch circuit is operable in the second state in response to the monitoring circuit detecting the protocol select signal for applying the first mode select signal to the signal processing circuit.

Preferably, the switch circuit is operable in the first state in response to one of a high and low logic state of a switch signal outputted by the monitoring circuit, and the switch circuit is operable in the second state in response to the other of the high and low logic states of the switch signal outputted by the monitoring circuit.

Advantageously, the first mode select signal is one of a logic high and a logic low signal, and the second mode select signal is the other of a logic high or a logic low signal.

In one embodiment of the invention the logic high signal which provides the one of the first and second mode select signals is provided by the supply voltage of the interface circuit, and is applied to the signal processing circuit through the switch circuit when the switch circuit is in the first state.

In another embodiment of the invention the logic low signal which provides the one of the first and second mode select signals is provided by ground of the interface circuit, and is applied to the signal processing circuit through the switch circuit when the switch circuit is in the second state.

In a further embodiment of the invention the first and second mode select signals are applied to one of the communication terminals simultaneously with the protocol select signal being applied to another one of the communication terminals, and a mode signal latching means is provided responsive to the protocol select signal for latching the one of the first and second mode select signals applied to the communication terminal.

Preferably, the latched one of the first and second mode select signals is applied from the mode signal latching means to the signal processing circuit through the switch circuit, when the switch circuit is in the second state.

In one embodiment of the invention the switch circuit comprises a multiplexer.

In another embodiment of the invention the monitoring circuit comprises a first state machine for monitoring the communication terminal on which the protocol select signal is to be applied, and for outputting one of a logic high and a logic low signals in response to the interface circuit being powered up, and the other of the logic high and the logic low signals on the protocol select signal being detected, the switch signal outputted by the monitoring circuit being derived from the logic signal outputted by the first state machine.

Preferably, a switch signal latching means is provided for alternately latching the switch signal in the one of the high and low logic states in response to the logic state of the output signal of the first state machine. Advantageously, the switch signal latching means is responsive to the protocol select signal after power-up of the interface circuit for altering the logic state of the switch signal for operating the switch circuit from the first state to the second state, and for latching the switch signal in the altered logic state.

In one embodiment of the invention the locking circuit comprises an inverter for inverting the switch signal, and an AND gate for ANDing the inverted switch signal with the output signal of the first state machine and for applying the ANDed signal to the switch signal latching means for altering the logic state of the switch signal for operating the switch circuit in the second state in response to the protocol select signal after power-up, and the AND gate is responsive to the altered logic state of the switch signal for inhibiting the protocol select signal being applied to the switch signal latching means, so that the switch signal latching means retains the switch signal latched in the altered logic state.

In another embodiment of the invention a second state machine is provided, the second state machine being responsive to the mode select signal applied to the signal processing circuit for applying a timing select signal to the signal processing circuit, for selecting the timing of the signal processing circuit to correspond with the one of the first and second protocol modes in which the signal processing circuit is configured.

In one embodiment of the invention the protocol select signal comprises a signal which transitions from one of high and low states to the other of the high and low states.

In another embodiment of the invention the monitoring circuit is responsive to one of a rising and falling edge of the protocol select signal as the protocol select signal transitions from the one of the high and low states to the other of the high and low states. Preferably, the monitoring circuit is responsive to a predetermined number of edges of the protocol select signal as the protocol select signal transitions from the one of the high and low states to the other of the high and low states. Advantageously, the monitoring circuit is responsive to a predetermined number of rising edges of the protocol select signal.

In one embodiment of the invention the monitoring circuit is responsive to a predetermined number of rising edges of the protocol select signal.

In one embodiment of the invention one of the first and second protocols is SPI protocol, and the other of the first and second protocols is one or both of I²C and SMBus protocols. Preferably, at least three communication terminals are provided for facilitating communication in both the SPI protocol and one or both of the I²C and SMBus protocols.

In one embodiment of the invention one of the communication terminals is a clock signal receiving terminal for receiving clock signals for communicating in the SPI protocol and one or both of the I²C and SMBus protocols, and one of the communication terminals is a chip enable terminal for receiving a chip enable signal for communicating in the SPI protocol.

In another embodiment of the invention at least one of the communication terminals is a serial data address terminal for communicating serial data in the SPI protocol, and for communicating serial data and addresses in one or both of the I²C and SMBus protocols.

In a further embodiment of the invention two of the communication terminals are serial data address terminals, one of which communicates serial data into the interface circuit, and one of which communicates serial data out of the interface circuit in the SPI protocol, and one of the two serial data address terminals communicates serial data and addresses with the interface circuit in one or both of the I²C and SMBus protocols.

Advantageously, terminal is provided for receiving clock signals for communicating in the I²C and/or SMBus protocols, and one of the two serial data address terminals communicates addresses with the interface circuit in one or both of the I²C and SMBus protocols.

Preferably, the first protocol is one or both of the I²C and SMBus protocols.

In one embodiment of the invention the chip enable terminal is adapted for receiving the protocol select signal.

In another embodiment of the invention the serial data address terminals is adapted for receiving the first and second mode select signals.

Additionally the invention provides an integrated circuit comprising an interface circuit according to the invention, and an associated device, the interface circuit being provided for communicating the associated device with an external device in either of the first protocol and the second protocol.

Further, the invention provides an integrated circuit comprising:

an interface circuit, and

an associated device, wherein

the interface circuit is alternately configurable in one of a first communication protocol mode for communicating in a first communication protocol and a second communication protocol mode for communicating in a second communication protocol, and for interfacing the associated device with an external device for communicating the associated device with the external device in one of the first communication protocol and the second communication protocol, the interface circuit being configured in the first protocol mode on power-up, the interface circuit comprising

a plurality of communication terminals for communicating signals in the first and second protocols between the interface circuit and the external device, the number of communication terminals required not exceeding the number of communication terminals required to communicate in the one of the first and second protocols which requires the greatest number of communication terminals, and

a monitoring circuit for monitoring one of the communication terminals for a protocol select signal, and being responsive to the protocol select signal for configuring the interface circuit in the second protocol mode.

Further, the invention provides a method for communicating through an interface circuit between an associated device associated with the interface circuit and an external device in either one of a first communication protocol and a second communication protocol, the method comprising the steps of:

providing the interface circuit with a plurality of communication terminals for communicating with the external device, the number of communicating terminals required not exceeding the number of communicating terminals required to communicate in the one of the first and second protocols which requires the greatest number of communication terminals,

providing the interface circuit with a monitoring circuit for monitoring one of the communication terminals for a protocol select signal,

configuring the interface circuit in a first protocol mode on power-up of the interface circuit for communicating in the first protocol,

monitoring the one of the communication terminals by the monitoring circuit for the protocol select signal, and

configuring the interface circuit in a second protocol mode for communicating in the second protocol in response to detection of a protocol select signal.

In one embodiment of the invention the interface circuit is locked configured in the second protocol mode in response to the protocol select signal.

In another embodiment of the invention the interface circuit is locked configured in the first protocol mode in response to the protocol select signal.

In a further embodiment of the invention the interface circuit is releasably locked in the configured protocol mode.

In a still further embodiment of the invention the interface circuit is released from the configured protocol mode in response to powering-down of the interface circuit.

Advantages of the Invention

The advantages of the invention are many. The interface circuit according to the invention facilitates communication between an associated device and one or more external devices in either a first or a second communication protocol, and the number of communication terminals required by the interface circuit is minimised. In fact, the number of communication terminals required by the interface circuit is equal to the number of communication terminals required by the one of the first and second communication protocols which requires the greatest number of communication terminals. No additional protocol select terminals are required, nor are any additional communication terminals required for the other of the two protocols. As well as minimising the number of communication terminals required, there is no danger of any of the communication being lost while the interface circuit is being configured to the appropriate communication protocol mode. In fact, the interface circuit is fully configured to the appropriate protocol mode before any communication takes place. Since the interface circuit is configured in the first protocol mode on power-up, if communication is to be in the first protocol, the interface circuit is configured in the first protocol mode before any communication takes place. If, on the other hand, communication is to be in the second protocol, the interface circuit is configured into the second protocol mode in response to the protocol select signal, which is transmitted before any communication in the second communication protocol commences, and accordingly, there is no danger of any of the communication in the second protocol being lost.

Additionally, the interface circuit is configurable in the desired one of the first and second protocol modes without the need for any additional protocol select pins, since the interface circuit is configured on power-up in the first protocol mode, and the interface circuit is configured in the second protocol mode in response to the protocol select signal, which is provided on one of the communication terminals, thus negating the need for an additional protocol select terminal.

A further advantage of the invention is achieved when the interface circuit is provided with a locking circuit for locking the interface circuit in the second protocol, since this avoids any danger of the interface circuit being inadvertently reconfigured to the first protocol after the second protocol had been selected. However, by providing the locking circuit as being releasable and in particular, being releasable on powering-down of the interface circuit, the interface circuit can readily be reconfigured in the first protocol by momentarily powering-down the interface circuit.

A further advantage of the invention is achieved where communication in the first protocol does not require use of the communication terminal which is being monitored for the protocol select signal, since in this case the interface circuit may be locked in the first protocol configuration by coupling the terminal being monitored to a fixed DC voltage level, for example, ground or the supply voltage, thereby preventing any danger of detection of a spurious signal which could inadvertently select the second protocol. The first protocol configuration can then be unlocked by merely decoupling the communication terminal being monitored for the protocol select signal from the fixed level voltage.

In the embodiment of the invention in which the first and second mode select signals are applied to one of the communication terminals, a further advantage is achieved, by virtue of the fact that the interface circuit can be locked in the respective first and second protocol modes in response to the protocol select signal.

A particularly important advantage of the invention is achieved by the simplicity of the monitoring circuit, and in particular, by the simplicity of the combination of the monitoring and the locking circuit. By virtue of the simplicity, the die area required to implement the interface circuit is minimised, and additionally, the interface circuit has a rapid response time.

The invention and its advantages will be more clearly understood from the following description of a preferred embodiment thereof, which is given by way of example only, with reference to the accompanying drawings.

### BRIEF DESCRIPTION OF THE DRAWINGS

FIG. 1 is a block representation of an interface circuit according to the invention for communicating an associated device with one or more external devices in either one of a first and second communication protocol,

FIGS. 2(a) and (b) illustrate timing diagrams of two different forms of a protocol select signal for configuring the interface circuit of FIG. 1 to communicate in one of the protocols,

FIG. 3 is a block representation of an interface circuit according to another embodiment of the invention for communicating an associated device with one or more external devices in either one of a first and second communication protocol, and

FIGS. 4(a) and (b) illustrate timing diagrams of two protocol select signals for configuring the interface circuit of FIG. 3 to communicate in the respective protocols.

### DETAILED DESCRIPTION OF A PREFERRED EMBODIMENT OF THE INVENTION

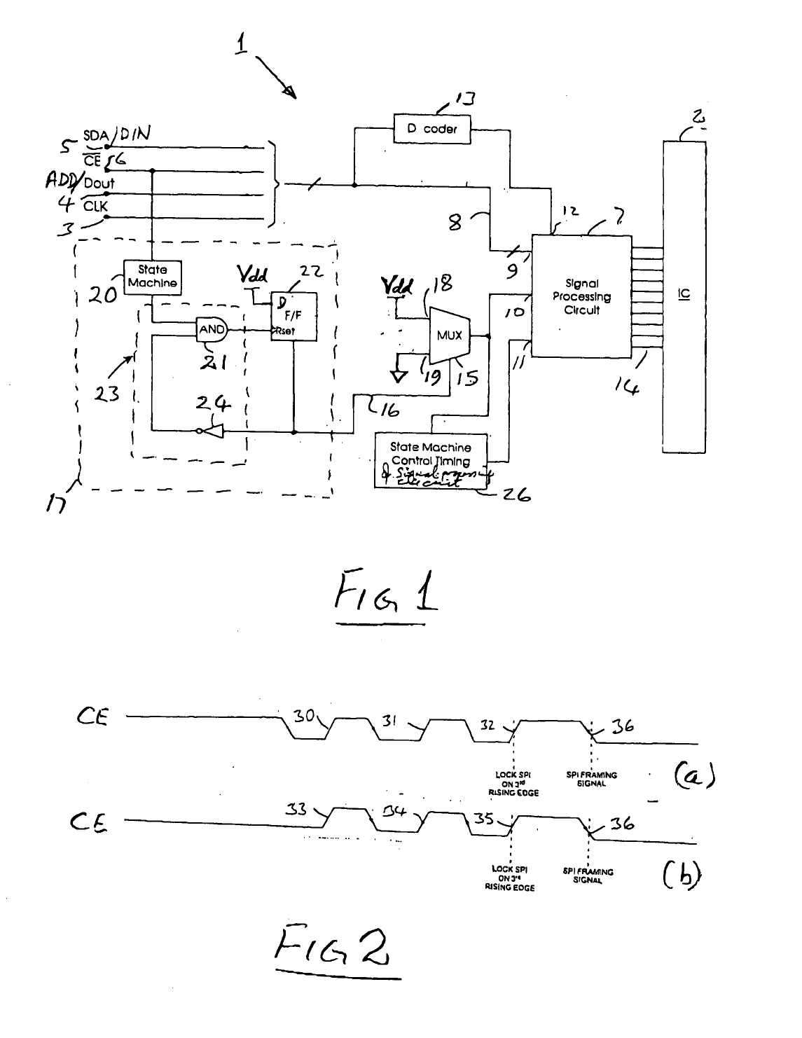

Referring to the drawings and initially to FIG. 1, there is illustrated an interface circuit according to the invention, indicated generally by the reference numeral 1, which is alternately configurable in one of a first communication protocol mode and a second communication protocol mode for interfacing an associated device, namely, an integrated circuit 2 with one or more external devices (not shown), so that the external devices can communicate with the integrated circuit 2 in either one of a first communication protocol and a second communication protocol. In this embodiment of the invention the first protocol is the I²C communication protocol, and the second protocol is the SPI communication protocol. However, due to the substantial similarity in the I²C and the SMBus communication protocols, the interface circuit 1 when configured to communicate in the first protocol mode can communicate in both the I²C and the SMBus protocols. Thus, for convenience, the first communication protocol from here on will be referred to as the I²C/SMBus protocol, and the first communication protocol mode will be referred to as the I²C/SMBus protocol mode. Additionally, the second communication protocol will be referred to as the SPI protocol, and the second communication protocol mode will be referred to as the SPI protocol mode.

The integrated circuit 2 may be any type of integrated circuit which would be required to communicate with external devices in SPI protocol and either or both of I²C and SMBus, and typically, would comprise, for example, a digital to analogue converter, an analogue to digital converter, a video encoder/decoder, a measuring or a monitoring circuit, for example, a measuring or monitoring circuit of the type used for measuring or monitoring temperature, pressure or the like, or any other circuit with which external devices would wish to communicate in any of I²C, SMBus and SPI protocols. The interface circuit 1 may be implemented separately from the integrated circuit 2, however, in general, the interface circuit 1 and the integrated circuit 2 will be implemented on the same chip, and in this embodiment of the invention both are implemented as a single integrated circuit.

The interface circuit 1 comprises four communication terminals through which communication is carried out between the integrated circuit 2 and the external device or devices (not shown). The communication terminals are provided as four pins, namely, a clock CLK pin 3, an address and serial data out ADD/DOUT pin 4, a serial data address and a serial data in SDA/DIN pin 5, and a chip enable \overline{CE} pin 6, which is active low. When communicating in SPI protocol, all four pins 3 to 6 are required to provide for two-way communication between the external device and the integrated circuit 2. The chip enable pin 6 and the clock pin 3 act respectively as chip enable and clock signal pins for receiving a chip enable signal and a clock signal, respectively, when the interface circuit is configured in the SPI protocol mode. Pulling the chip enable pin 6 low indicates the commencement of communication in SPI protocol. In this embodiment of the invention a protocol select signal is applied to the chip enable pin 6 for configuring the interface circuit 1 in the SPI protocol mode as will be described below. When configured in SPI protocol mode, data is read into the integrated circuit 2 through the SDA/DIN pin 5, and data is read out from the integrated circuit 2 through the ADD/DOUT pin 4. When configured in the I²C/SMBus protocol mode, only two of the pins are required, namely, the clock pin 3, for the clock signal, and the SDA/DIN pin 5 through which serial data and addresses are read into and out of the integrated circuit 2. Additionally, when the interface circuit 1 is configured in the I²C/SMBus protocol mode, the ADD/DOUT pin 4 may also be used as an address select pin, although this is not necessary. When acting as an address select pin in the I²C/SMBus protocol mode, the ADD/DOUT pin 4 may be configured high, low or floating for facilitating assigning specific addresses to the integrated circuit 2. In order to avoid the need for a read/write pin in the interface circuit 1 when communicating in SPI protocol, read and write signals are embedded in the data being communicated with the interface circuit 1, and the interface circuit 1 is configured to read the read/write signals from the data when the interface circuit 1 is configured in the SPI protocol mode.

A signal processing circuit 7 is configurable for processing the signals in either one of the I²C/SMBus and SPI protocols being written to or read from the integrated circuit 2 so that the data being received by the interface circuit 1 is converted from the protocol in which it is received into a format which is readable by the integrated circuit 2, and data to be transmitted by the integrated circuit 2 to the external device or devices is converted into the appropriate protocol prior to transmission from the interface circuit 1. In this embodiment of the invention on powering-up of the interface circuit 1, the signal processing circuit 7 is automatically configured in the I²C/SMBus protocol mode, and is selectively configurable in the SPI protocol mode in response to the protocol select signal on the chip enable pin 6 as will be described below.

A four line bus 8 applies signals received on the four pins 3 to 6 to an I/O port 9 of the signal processing circuit 7. A mode select input port 10 of the signal processing circuit 7 receives first and second mode select signals for configuring the signal processing circuit 7 in the I²C/SMBus or SPI protocol modes, respectively, as will be described below. A timing select input port 11 of the signal processing circuit 7 received a timing select signal for selecting the appropriate timing of the signal processing circuit 7 corresponding to the selected one of the I²C/SMBus and SPI protocol modes. As will be understood by those skilled in the art, I²C and SMBus protocol timing requires nine clock cycles for one byte of data, while in this embodiment of the invention the SPI protocol timing requires eight clock cycles for one byte of data. An input port 12 of the signal processing circuit 7 receives a signal from a decoder 13 for indicating commencement of a communication in the SPI protocol. The decoder 13 decodes signals on the bus 8 for determining commencement of communication in SPI protocol, when the interface circuit 1 is configured in the SPI protocol mode. A bus 14 communicates the signal processing circuit 7 with the integrated circuit 2.

A switch circuit, in this embodiment of the invention a multiplexer 15, is operable in respective first and second states in response to a switch signal on a line 16 from a monitoring circuit 17 for selectively switching the first and second mode select signals to the mode select input port 10 of the signal processing circuit 7. The first mode select signal is a logic high signal which is provided by the supply voltage V_{dd} of the interface circuit 1, and is applied to a first input 18 of the multiplexer 15. The second mode select signal is applied to a second input 19 of the multiplexer 15, and is a logic low signal, which in this embodiment of the invention is provided by ground of the interface circuit 1. The switch signal on the line 16 is a logic signal, and the multiplexer 15 is operable in the first state in response to the switch signal being in the logic low state for applying the first mode select signal on the first input 18 to the mode select input port 10 for configuring the signal processing circuit 7 in the I²C/SMBus protocol mode. The multiplexer 15 is responsive to the switch signal on the line 16 being in the logic high state for applying the second mode select signal on the second input 19 to the mode select input port 10 for configuring the signal processing circuit 7 in the SPI protocol mode.

The monitoring circuit 17 comprises a first state machine 20, an input of which is coupled to the chip enable pin 6 for monitoring the chip enable pin 6 for the protocol select signal. An output of the first state machine 20 is coupled to one input of an AND gate 21 for outputting a logic signal in response to the state of the chip enable pin 6. The first state machine 20 outputs a logic low signal to the AND gate 21 for so long as the chip enable pin 6 remains continuously high or continuously low after power-up of the interface circuit 1. The output of the first state machine 20 goes into a logic high state in response to the protocol select signal appearing on the chip enable pin 6. A switch signal latching means, namely, a switch signal D-type flip-flop 22 of the monitoring circuit 17 outputs the switch signal on the line 16 in response to the logic state of the output of the first state machine 20. A D-input of the switch signal flip-flop 22 is coupled to a logic high, in this embodiment of the invention provided by the supply voltage V_{dd}. An active high reset input of the switch signal flip-flop 22 is coupled to the output of the AND gate 21. On power-up of the interface circuit 1 the output of the switch signal flip-flop 22 on the line 16 is in the logic low state. For so long as the output from the AND gate 21 holds the reset input of the switch signal flip-flop 22 low, the output from the switch signal flip-flop 22 on the line 16 remains in the logic low state, and thus the multiplexer 15 applies the first mode select signal to the signal processing circuit 7. As will be described below, on the AND gate 21 applying a logic high to the reset input of the switch signal flip-flop 22, the switch signal outputted on the line 16 goes to the logic high state, thus operating the multiplexer 15 in the second state for applying the second mode select signal to the signal processing circuit 7.

A locking circuit 23 for locking the interface circuit 1 in the SPI protocol mode after it has been configured into the SPI protocol mode comprises an inverter 24 for inverting the switch signal on the line 16, and applying the inverted switch signal to the other input of the AND gate 21. Since the switch signal on the line 16 on power-up is initially at logic low, the inverted switch signal applied to the AND gate 21 is at logic high. On detecting the protocol select signal on the chip enable pin 6, the first state machine 20 outputs a logic high to the AND gate 21, thus causing the AND gate 21 to output a logic high to the reset input, which causes the switch signal flip-flop 20 to output the switch signal in the logic high state on the line 16. The switch signal in the logic high state operates the multiplexer 15 in its second state for applying the second mode select signal from the second input 19 to the mode select input port 10 for configuring the signal processing circuit 7 in the SPI protocol mode. The inverter 24 inverts the logic high switch signal, thus applying a logic low to the AND gate 21 which in turn outputs a logic low to the reset input of the switch signal flip-flop 22. Since the inverter 24 holds one of the inputs to the AND gate 21 low, the AND gate 21 inhibits further changes in the output from the first state machine 20 being applied to the reset input of the switch signal flip-flop 22, thereby locking the interface circuit 1 in the SPI protocol mode.

A second state machine 26 is responsive to the mode select signal from the multiplexer 15 for applying a corresponding timing select signal to the timing select input port 11 of the signal processing circuit 7 for selecting the timing of the signal processing circuit 7 appropriate to the protocol mode into which the signal processing circuit 7 has been configured in response to the mode select signal from the multiplexer 15.

Referring now to FIGS. 2(a) and 2(b), the protocol select signal which is applied to the chip enable pin 6 for configuring the interface circuit 1 in the SPI protocol mode will now be described. As discussed above, the chip enable pin 6 may be continuously in a high or a low state after power-up, and for so long as the chip enable pin 6 is in either the continuous high or the continuous low state, the interface circuit 1 is configured in the I²C/SMBus protocol mode. The protocol select signal is provided by a number of pulses applied to the chip enable pin 6, which in this embodiment of the invention provide three rising edges, and the first state machine 20 is responsive to the third rising edge for outputting the logic high. Thus, when the chip enable pin 6 is in a continuously high state, three low going pulses are required for providing three rising edges 30, 31 and 32, see FIG. 2(a). When the chip enable pin 6 is in a continuously low state, two high going pulses are required to provide three rising edges, namely, three rising edges 33, 34 and 35, see FIG. 2(b). The duration of the low going or high going pulses may be any suitable time period, however, in general, the minimum duration of each pulse should be in the order of 20 nanoseconds. The time period between the low or high going pulses is not relevant, the first state machine 20 merely counts three rising edges on the chip enable pin 6. After the third rising edge 32 or 35 of the protocol select signal on the chip enable pin 6, the chip enable pin 6 is held high until communication in the SPI protocol is about to commence. The chip enable pin 6 is then pulled low to form a low going SPI framing signal 36 which indicates the commencement of communication in the SPI protocol. The decoder 13 decodes the SPI framing signal 36 for outputting the signal to the input port 12 of the signal processing circuit 7 for indicating commencement of communication in the SPI protocol.

In use, on power-up of the interface circuit 1, with the chip enable pin 6 high or low, the first state machine 20 outputs a logic low signal to the AND gate 21, which applies a logic low to the reset input of the switch signal flip-flop 22. The switch signal flip-flop 22 thus outputs the switch signal on the line 16 in the logic low state to the multiplexer 15, which in turn operates the multiplexer in the first state for applying the first mode select signal from the first input 18 to the mode select input port 10 for configuring the signal processing circuit 7 in the I²C/SMBus protocol mode. The second state machine 26 in response to the first mode select signal configures the timing of the signal processing circuit 7 appropriately. The inverter 24 of the locking circuit 23 applies a logic high to the AND gate 21 for so long as the switch signal from the switch signal flip-flop 22 remains in the logic low state.

Should it be desired to lock the interface circuit 1 in the I²C/SMBus protocol mode, this can be done by tying the chip enable pin 6 to a continuously fixed DC voltage, for example, the supply voltage V_{dd}, or ground. However, it is preferable that the chip enable pin should be tied to the supply voltage V_{dd} for locking the interface circuit 1 in the I²C/SMBus protocol mode.

Should it be desired to communicate in the SPI protocol, the protocol select signal is applied to the chip enable pin 6. On the third rising edge of the protocol select signal the first state machine 20 outputs a logic high, which with the logic high from the inverter 24, causes the AND gate 21 to apply a logic high to the reset input of the switch signal flip-flop 22. This causes the switch signal flip-flop 22 to output the switch signal on the line 16 in a logic high state, which thus operates the multiplexer 15 in the second state for applying the second mode select signal from the second input 19 to the mode select input port 10 for configuring the signal processing circuit 7 in the SPI protocol mode. The second state machine 26 in response to the second mode select signal configures the timing of the signal processing circuit 7 appropriately.

On the switch signal from the switch signal flip-flop 22 going logic high, the inverter 24 of the locking circuit 23 applies a logic low to the AND gate 21, which in turn applies a logic low to the reset input of the switch signal flip-flop 22. The switch signal flip-flop 22 continues to output the switch signal in the logic high state until a logic high signal is applied to the reset input again goes high. However, since the inverter 24 holds one of the inputs to the AND gate 21 low, the AND gate 21 is insensitive to any further changes in the output of the first state machine 20, and thus, inhibits any further change in the output of the first state machine 20 being applied to the reset input of the switch signal flip-flop 22. Accordingly, the reset input of the switch signal flip-flop 22 is held continuously low by the AND gate 21 until the interface circuit 1 is powered down. Thus the interface circuit 1 is locked in the SPI protocol mode. Communication in SPI commences when the SPI framing signal 36 is detected on the chip enable pin 6 by the decoder 13, which outputs a signal to the input port 12 of the signal processing circuit 7, indicating the commencement of communication in SPI protocol.

On powering down of the interface circuit 1, the locking function of the locking circuit 23 is released, and on repowering of the interface circuit 1, for so long as the chip enable pin 6 remains continuously high or continuously low the interface circuit 1 is configured in the I²C/SMBus protocol mode. Thus, the interface circuit 1 can be readily reconfigured from the SPI protocol mode to the I²C/SMBus protocol mode by momentarily powering down the interface circuit 1.

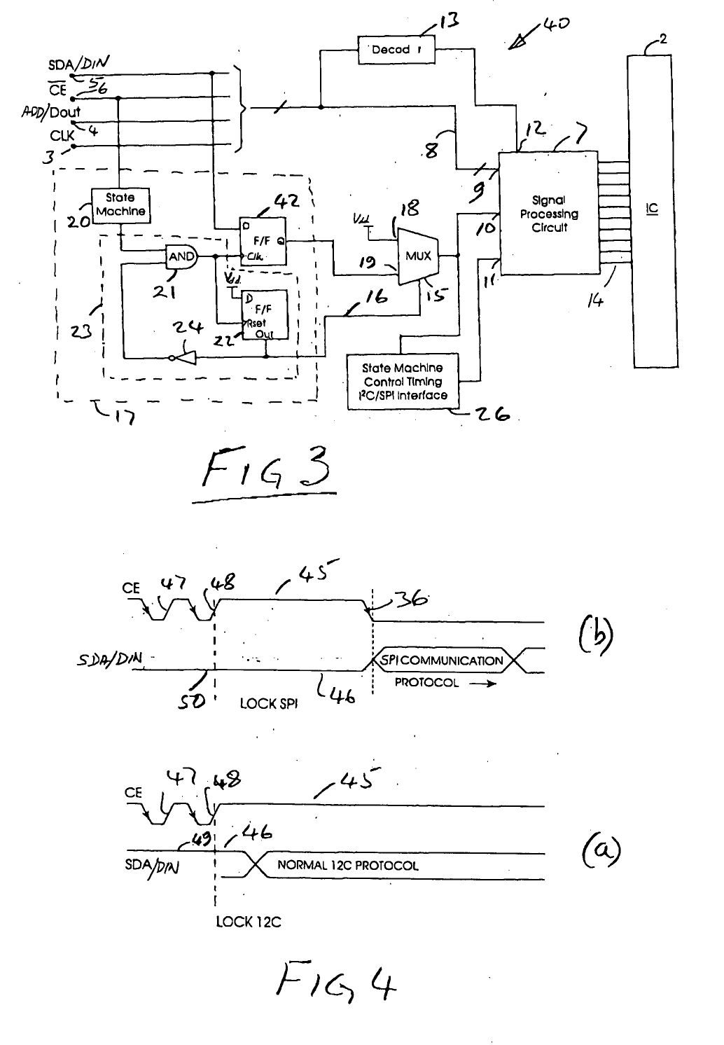

Referring now to FIGS. 3 and 4, there is illustrated an interface circuit according to another embodiment of the invention, indicated generally by the reference numeral 40. The interface circuit 40 is substantially similar to the interface circuit 1 and similar components are identified by the same reference numerals. In this embodiment of the invention the interface circuit 40 is also configurable in the I²C/SMBus protocol mode, and in the SPI protocol mode for interfacing an integrated circuit 2 with external devices (not shown). The main difference between the interface circuit 40 and the interface circuit 1 is that the monitoring circuit 17 monitors both the chip enable pin 6 and the SDA/DIN pin 5. The protocol select signal is applied to the chip enable pin 6, and in this embodiment of the invention, first and second mode select signals are applied to the SDA/DIN pin 5, simultaneously as the protocol select signal is being applied to the chip enable pin 6, as will be described below. In this embodiment of the invention the interface circuit 40 can be locked by the locking circuit 23 in both the SPI protocol mode and the I²C/SMBus protocol mode, as will be described below.

The multiplexer 15 is operable in the first and second states in response to the switch signal on the line 16 in similar fashion as the multiplexer 15 is operable in the interface circuit 1. Additionally, operation of the switch signal flip-flop 22 in response to the first state machine 20 detecting the protocol select signal on the chip enable pin 6 is also similar to the operation of the switch signal flip-flop 22 of the interface circuit 1. The operation of the locking circuit 23 is also similar to that of the locking circuit 23 of the interface circuit 1.

Accordingly, on power-up of the interface circuit 40 the switch signal flip-flop 22 outputs the switch signal on the line 16 in the logic low state, thereby operating the multiplexer 15 in the first state for applying the first mode select signal provided by the supply voltage V_{dd} to the mode select input port 10 for configuring the signal processing circuit 7 in the I²C/SMBus protocol mode.

In this embodiment of the invention the monitoring circuit 17 comprises a mode signal latching means, namely, a mode signal D-type flip-flop 42 for latching the mode select signal from the SDA/DIN pin 5. A D-input of the mode signal flip-flop 42 is coupled to the SDA/DIN pin 5 for receiving the mode select signal therefrom. A Q-output of the mode signal flip-flop 42 is coupled to the second input 19 of the multiplexer 15. An active high clock input of the mode signal flip-flop 42 is coupled to the output of the AND gate 21. On the protocol select signal and one of the first and second mode select signals being applied to the chip enable pin 6 and the SDA/DIN pin 5, respectively, the AND gate applies a logic high to the reset input of the switch signal flip-flop 22, and also to the clock input of the mode signal flip-flop 42. The logic high on the reset input of the switch signal flip-flop 22 switches the output from the switch signal flip-flop 22 to the logic high state, thus operating the multiplexer 15 in the second state for applying the signal from the second input 19 of the multiplexer 15 to the mode select input port 10 of the signal processing circuit 7. The logic high on the clock input of the mode signal flip-flop 42 switches the mode select signal on the D-input to the Q-output and latches the mode select signal on the Q-output of the mode signal flip-flop 42. The mode signal on the Q-output of the mode signal flip-flop 42 is thus applied through the multiplexer 15 to the mode select input port 10 for configuring the signal processing circuit 7 in the appropriate one of the protocol modes in response to the mode select signal.

If the mode select signal applied to the SDA/DIN pin 5 is the second mode select signal, the signal processing circuit 7 is configured in the SPI protocol. On the other hand, if the mode select signal applied to the SDA/DIN pin 5 is the first mode select signal, the signal processing circuit 7 remains configured in the I²C/SMBus protocols, however, instead of the first mode select signal being applied to the mode select input port 10 from the first input 18 of the multiplexer 15, the first mode select signal is applied to the mode select input port 10 from the Q-output of the mode signal flip-flop 42 through the second input 19 of the multiplexer 15. Irrespective of whether the mode select signal applied to the SDA/DIN pin 5 is the first mode select signal or the second mode select signal, once the switch signal from the switch signal flip-flop 22 goes into the logic high state the locking circuit 23 retains the output of the AND gate at logic low irrespective of the output of the first state machine 20. The mode select signal is thereby retained latched on the Q-output of the mode signal flip-flop 42, and the switch signal on the line 16 from the switch signal flip-flop 22 is retained in the logic high state. Thus, the interface circuit 40 is automatically locked in the selected one of the I²C/SMBus and the SPI protocols, once the respective ones of the I²C/SMBus and SPI protocols have been selected by applying the appropriate one of the first and second mode select signals on the SDA/DIN pin 5.

Referring now to FIGS. 4(a) and 4(b), FIGS. 4(a) and (b) illustrate the configuration of the protocol select signal and the mode select signal to be applied respectively to the chip enable pin 6 and the SDA/DIN pin 5. FIG. 4(a) illustrates the configuration of the protocol select signal and the first mode select signal for selecting and locking the interface circuit 40 in the I²C/SMBus protocol modes, while FIG. 4(b) illustrates the configuration of the two signals for locking the interface circuit 40 in the SPI protocol mode. The protocol select signal is indicated by the reference numeral 45, while the mode select signal is indicated by the reference numeral 46. In this embodiment of the invention the protocol select signal 45 comprises only two rising edges 47 and 48. The first state machine 20 is responsive to the second rising edge 48 for outputting the logic high signal to the AND gate 21. If the chip enable pin is high as illustrated in FIGS. 4(a) and 4(b), two low going pulses are required to provide the two rising edges 47 and 48. On the other hand, if the chip enable pin is at logic low, then only one high going pulse is required to provide the two rising edges 47 and 48. Since the first mode select signal is a logic high signal, the SDA/DIN pin 5 is pulled high at 49, see FIG. 4(a) so that the SDA/DIN pin 5 is high at the second rising edge 48 of the protocol select signal 45 for selecting the I²C/SMBus protocol mode. In this way, the high first mode select signal 49 is latched onto the Q-output of the mode signal flip-flop 42 in response to the logic high being applied to its clock input by the AND gate 21. On the other hand, since the second mode select signal is a logic low signal, the SDA/DIN pin 5 is pulled low at 50, see FIG. 4(b), so that the second mode select signal is latched onto the Q-output of the mode signal flip-flop 42 when the AND gate 21 applies a logic high to the clock input of the mode signal flip-flop 42 in response to the second rising edge 48 of the protocol select signal 45. When the SPI protocol is selected, the chip enable pin 6 remains at logic high until communication in SPI is about to commence, in which case the chip enable pin 6 is pulled low to form the SPI framing signal 36 as already described with reference to FIG. 2. If the I²C/SMBus protocol mode has been selected, the chip enable pin 6 may be left high or low, since it is not required in I²C or SMBus communication, and once a protocol mode has been selected the interface circuit 40 remains locked in the selected protocol mode until the interface circuit is powered down.

In use, on power-up the interface circuit 40 is configured in I²C/SMBus protocol mode as already described with reference to the interface circuit 1. If desired, communication can be carried out with the interface circuit 40 so configured, however, the interface circuit 40 in this mode of operation is unstable. Thus, in normal use if it is desired to communicate in I²C or SMBus protocols, the I²C/SMBus protocol mode is selected by simultaneously applying the protocol select signal to the chip enable pin 6 and the first mode select signal to the SDA/DIN pin 5. Alternatively, if it is desired to communicate in the SPI protocol, the protocol select signal and the second mode select signal are applied simultaneously to the chip enable pin 6 and the SDA/DIN pin 5, respectively.

Otherwise, operation of the interface circuit 40 is similar to that of the interface circuit 1.

While the interface circuits according to the invention have been described as being configurable to communicate in I²C/SMBus and SPI protocols, it will be readily apparent to those skilled in the art that the interface circuits according to the invention may be configurable to operate in any two desired protocols. It will also be appreciated that in certain circumstances, the interface circuits according to the invention may be configured to power-up in SPI protocol, and would be selectively configurable to communicate in I²C/SMBus protocols in response to the protocol select signal.

It will be appreciated that the number of communicating terminals provided for the interface circuit will be dependent on the protocols in which the interface circuits are to be adapted to communicate, and in particular, will be dependent on the number of communicating terminals required by the protocol which requires the greatest number of communicating terminals. It is envisaged that in certain cases, where only one-way communication is required, for example, where it is desired that the external device or devices need only read out data from the integrated circuit 2, and writing to the integrated circuit 2 is not required, SDA/DIN the pin 5 could be reconfigured as an SDA/DOUT pin, and the ADD/DOUT pin 4 could be omitted, thus reducing the number of communication pins required to three.

While the protocol select signal of the interface circuit of FIG. 1 has been described as comprising a predetermined number of rising edges of pulses on the chip enable pin, it will be readily apparent to those skilled in the art that the protocol select signal may be provided by any other suitable signal or signals. For example, the protocol select signal may comprise a predetermined number of falling edges of pulses, and the predetermined number of rising or falling edges, as the case may be, may be any number from one upwards. However, by providing the protocol select signal as comprising more than one pulse, any danger of mis-selecting a protocol as a result of a spurious signal is avoided. Additionally, it is envisaged that the first state machine may be responsive to a count of both rising and falling edges of the signal on the chip enable pin. Additionally, while minimum durations of pulses of the protocol select signal have been described, the duration of the pulses may be any suitable time period. It is also envisaged that the protocol select signal of the interface circuit of FIG. 1 may be applied to another of the communicating terminals besides the chip enable pin, although the chip enable pin is the preferred pin, when the protocols are 1²C/SMBus and SPI. Additionally, the number of rising edges of the signal on the chip enable pin of the interface circuit described with reference to FIG. 3 may also be varied, and the first and second mode select signals may be derived from any other suitable ones of the communication terminals, besides the SDA/DIN pin 5.

While the flip-flops have been described as D type flip-flops, any other suitable type flip-flop may be provided.

While the interface circuit has been described as being fabricated on the same chip as the integrated circuit with which it is associated, the interface circuit may be fabricated as a stand alone device.

What is claimed is:

1. An interface circuit alternately configurable in one of a first communication protocol mode for communicating in a first communication protocol and a second communication protocol mode for communicating in a second communication protocol, and for interfacing an associated device with an external device for communicating the associated device with the external device in one of the first communication protocol and the second communication protocol, the interface circuit being configured in the first protocol mode on power-up, the interface circuit comprising
a plurality of communication terminals for communicating signals in the first and second protocols between the interface circuit and the external device, the number of communication terminals required not exceeding the number of communication terminals required to communicate in the one of the first and second protocols which requires the greatest number of communication terminals, and
a monitoring circuit for monitoring one of the communication terminals for a protocol select signal, and being responsive to the protocol select signal for configuring the interface circuit in the second protocol mode.

2. An interface circuit as claimed in claim 1 in which a locking circuit responsive to the monitoring circuit detecting the protocol select signal is provided for locking the interface circuit configured in the second protocol mode.

3. An interface circuit as claimed in claim 2 in which the locking circuit is responsive to the monitoring circuit detecting the protocol select signal for locking the interface circuit configured in the first protocol mode.

4. An interface circuit as claimed in claim 2 in which the locking circuit releasably locks the interface circuit in the configured protocol mode.

5. An interface circuit as claimed in claim 2 in which the locking circuit is responsive to powering down of the interface circuit for releasing the interface circuit from the configured protocol mode.

6. An interface circuit as claimed in claim 1 in which a signal processing circuit is provided, the signal processing circuit being selectively and alternately configurable in one of the first and second protocol modes for processing the communication signals in the respective first and second protocols, the signal processing circuit being configurable in the respective first and second protocol modes in response to first and second mode select signals, respectively.

7. An interface circuit as claimed in claim 6 in which a switch circuit is provided, the switch circuit being selectively and alternately operable in one of a first state and a second state in response to the monitoring circuit, the switch circuit being operable in the first state in response to the monitoring circuit on power-up of the interface circuit for applying the first mode select signal to the signal processing circuit.

8. An interface circuit as claimed in claim 7 in which the switch circuit is operable in the second state in response to the monitoring circuit detecting the protocol select signal for applying the second mode select signal to the signal processing circuit.

9. An interface circuit as claimed in claim 7 in which the switch circuit is operable in the second state in response to the monitoring circuit detecting the protocol select signal for applying the first mode select signal to the signal processing circuit.

10. An interface circuit as claimed in claim 7 in which the switch circuit is operable in the first state in response to one of a high and low logic state of a switch signal outputted by the monitoring circuit, and the switch circuit is operable in the second state in response to the other of the high and low logic states of the switch signal outputted by the monitoring circuit.

11. An interface circuit as claimed in claim 7 in which the first mode select signal is one of a logic high and a logic low signal, and the second mode select signal is the other of a logic high or a logic low signal.

12. An interface circuit as claimed in claim 11 in which the logic high signal which provides the one of the first and second mode select signals is provided by the supply voltage of the interface circuit, and is applied to the signal processing circuit through the switch circuit when the switch circuit is in the first state.

13. An interface circuit as claimed in claim 11 in which the logic low signal which provides the one of the first and second mode select signals is provided by ground of the interface circuit, and is applied to the signal processing circuit through the switch circuit when the switch circuit is in the second state.

14. An interface circuit as claimed in claim 7 in which one of the communication terminals is adapted for selectively receiving one of the first and second mode select signals simultaneously with the protocol select signal being applied to another one of the communication terminals, and a mode signal latching means is provided responsive to the protocol select signal for latching the one of the first and second mode select signals applied to the communication terminal.

15. An interface circuit as claimed in claim 15 in which the latched one of the first and second mode select signals is applied from the mode signal latching means to the signal processing circuit through the switch circuit, when the switch circuit is in the second state.

16. An interface circuit as claimed in claim 7 in which the switch circuit comprises a multiplexer.

17. An interface circuit as claimed in claim 10 in which the monitoring circuit comprises a first state machine for monitoring the communication terminal on which the protocol select signal is to be applied, and for outputting one of a logic high and a logic low signals in response to the interface circuit being powered up, and the other of the logic high and the logic low signals on the protocol select signal being detected, the switch signal outputted by the monitoring circuit being derived from the logic signal outputted by the first state machine.

18. An interface circuit as claimed in claim 17 in which a switch signal latching means is provided for alternately latching the switch signal in the one of the high and low logic states in response to the logic state of the output signal of the first state machine.

19. An interface circuit as claimed in claim 18 in which the switch signal latching means is responsive to the protocol select signal after power-up of the interface circuit for altering the logic state of the switch signal for operating the switch circuit from the first state to the second state, and for latching the switch signal in the altered logic state.

20. An interface circuit as claimed in claim 19 in which the locking circuit comprises an inverter for inverting the switch signal, and an AND gate for ANDing the inverted switch signal with the output signal of the first state machine and for applying the ANDed signal to the switch signal latching means, the switch signal latching means being responsive to the output of the AND gate for altering the logic state of the switch signal for operating the switch circuit in the second state in response to the protocol select signal after power-up, and the AND gate is responsive to the altered logic state of the switch signal for inhibiting the protocol select signal being applied to the switch signal latching means, so that the switch signal latching means retains the switch signal latched in the altered logic state.

21. An interface circuit as claimed in claim 6 in which a second state machine is provided, the second state machine being responsive to the mode select signal applied to the signal processing circuit for applying a timing select signal to the signal processing circuit, for selecting the timing of the signal processing circuit to correspond with the one of the first and second protocol modes in which the signal processing circuit is configured.

22. An interface circuit as claimed in claim 1 in which the protocol select signal comprises a signal which transitions from one of high and low states to the other of the high and low states.

23. An interface circuit as claimed in claim 22 in which the monitoring circuit is responsive to one of a rising and falling edge of the protocol select signal as the protocol select signal transitions from the one of the high and low states to the other of the high and low states.

24. An interface circuit as claimed in claim 22 in which the monitoring circuit is responsive to a predetermined number of edges of the protocol select signal as the protocol select signal transitions from the one of the high and low states to the other of the high and low states.

25. An interface circuit as claimed in claim 24 in which the monitoring circuit is responsive to a predetermined number of rising edges of the protocol select signal.

26. An interface circuit as claimed in claim 1 in which one of the first and second protocols is SPI protocol, and the other of the first and second protocols is one or both of I²C and SMBus protocols.

27. An interface circuit as claimed in claim 26 in which at least three communication terminals are provided for facilitating communication in both the SPI protocol and one or both of the I²C and SMBus protocols.

28. An interface circuit as claimed in claim 27 in which one of the communication terminals is a clock signal receiving terminal for receiving clock signals for communicating in the SPI protocol and one or both of the I²C and SMBus protocols, and one of the communication terminals is a chip enable terminal for receiving a chip enable signal for communicating in the SPI protocol.

29. An interface circuit as claimed in claim 26 in which at least one of the communication terminals is a serial data address terminal for communicating serial data in the SPI protocol, and for communicating serial data and addresses in one or both of the I²C and SMBus protocols.

30. An interface circuit as claimed in claim 29 in which two of the communication terminals are serial data address terminals, one of which communicates serial data into the interface circuit, and one of which communicates serial data out of the interface circuit in the SPI protocol, and one of the two serial data address terminals communicates serial data and addresses with the interface circuit in one or both of the I²C and SMBus protocols.

31. An interface circuit as claimed in claim 30 in which terminal is provided for receiving clock signals for communicating in the I²C and/or SMBus protocols, and one of the two serial data address terminals communicates addresses with the interface circuit in one or both of the I²C and SMBus protocols.

32. An interface circuit as claimed in claim 26 in which the first protocol is one or both of the I²C and SMBus protocols.

33. An interface circuit as claimed in claim 28 in which the chip enable terminal is adapted for receiving the protocol select signal.

34. An interface circuit as claimed in claim 29 in which one of the serial data address terminals is adapted for receiving the first and second mode select signals.

35. An integrated circuit comprising an interface circuit as claimed in claim 1, and an associated device, the interface circuit being provided for communicating the associated device with an external device in either of the first protocol and the second protocol.

36. An integrated circuit comprising:
an interface circuit, and
an associated device, wherein
the interface circuit is alternately configurable in one of a first communication protocol mode for communicating in a first communication protocol and a second communication protocol mode for communicating in a second communication protocol, and for interfacing the associated device with an external device for communicating the associated device with the external device in one of the first communication protocol and the second communication protocol, the interface circuit being configured in the first protocol mode on power-up, the interface circuit comprising
a plurality of communication terminals for communicating signals in the first and second protocols between the interface circuit and the external device, the number of communication terminals required not exceeding the number of communication terminals required to communicate in the one of the first and second protocols which requires the greatest number of communication terminals, and
a monitoring circuit for monitoring one of the communication terminals for a protocol select signal, and being responsive to the protocol select signal for configuring the interface circuit in the second protocol mode.

37. A method for communicating through an interface circuit between a device associated with the interface circuit and an external device in either one of a first communication protocol and a second communication protocol, the method comprising the steps of:
providing the interface circuit with a plurality of communication terminals for communicating with the external device, the number of communicating terminals required not exceeding the number of communicating terminals required to communicate in the one of the first and second protocols which requires the greatest number of communication terminals,
providing the interface circuit with a monitoring circuit for monitoring one of the communication terminals for a protocol select signal,
configuring the interface circuit in a first protocol mode on power-up of the interface circuit for communicating in the first protocol,
monitoring the one of the communication terminals by the monitoring circuit for the protocol select signal, and
configuring the interface circuit in a second protocol mode for communicating in the second protocol in response to detection of the protocol select signal.

38. A method as claimed in claim 37 in which the interface circuit is locked configured in the second protocol mode in response to the protocol select signal.

39. A method as claimed in claim 38 in which the interface circuit is locked configured in the first protocol mode in response to the protocol select signal.

40. A method as claimed in claim 38 in which the interface circuit is releasably locked in the configured protocol mode.

41. A method as claimed in claim 38 in which the interface circuit is released from the configured protocol mode in response to powering-down of the interface circuit.
